(19) United States
(12) Patent Application Publication
(10) Pub. No.: US 2020/0328484 A1
(43) Pub. Date: Oct. 15, 2020

(54) Storage Device for Storing Electrical Energy for a Motor Vehicle

(71) Applicant: Bayerische Motoren Werke Aktiengesellschaft, Muenchen (DE)

(72) Inventors: Florian EINOEGG, Biessenhofen (DE); Kai HESSLING, Koeln (DE); Michael HUBER, Muenchen (DE)

(21) Appl. No.: 16/757,658

(22) PCT Filed: Dec. 13, 2018
(86) PCT No.: PCT/EP2018/084849

§ 371 Date: Apr. 20, 2020

(30) Foreign Application Priority Data
Dec. 14, 2017 (DE) 10 2017 222 771.0

(51) Int. Cl. H01M 10/625; H01M 10/6556; H01M 2/10

(52) U.S. Cl. CPC H01M 10/625; H01M 2220/20; H01M 2/1077; H01M 10/6556

(57) ABSTRACT

A storage device for storing electrical energy for a motor vehicle has a plurality of storage cells arranged one after the other along a stack direction and forming at least one cell stack for storing the electrical energy. A clamping device has two end plates and at least one tension element connected to the end plates, by which clamping device the storage cells arranged along the stack direction between the end plates are clamped together along the stack direction and are thereby held against one another. A temperature control device is designed to control the temperature of the storage cells, wherein at least the tension element is a functional component of the temperature control device and has: at least one duct, through which a temperature control medium can flow to control the temperature of the storage cells, at least one supply port via which the temperature control medium can be introduced into the duct, and at least one drainage port via which the temperature control medium can be drained out of the duct. The tension element is arranged on one side of the storage cells facing upwards or downwards in a vehicle vertical direction in the installed position of the storage device.

### BACKGROUND AND SUMMARY OF THE INVENTION

The invention relates to a storage device for storing electrical energy for a motor vehicle, in particular for a motor car.

A storage device of this kind for storing electrical energy for a motor vehicle, in particular for a motor car, has for example already been described as known in DE 10 2014 218 330 A1. The storage device comprises a plurality of storage cells successively arranged one after the other along a stacking direction and forming at least one cell stack for storing electrical energy. The storage device is thus for example a power supply device/a power supply module, which can supply electrical energy/electrical current. In particular the storage device is used as a traction storage device, in particular as a traction battery in order to, for example, supply at least one electrical machine of the motor vehicle with the electrical energy stored in the storage device. This allows the electrical machine to be operated as an electric motor for example, by means of which the motor vehicle can be electrically driven. The motor vehicle may thus, for example, be configured as a hybrid vehicle or electrical vehicle. Because the motor vehicle can be driven by means of the electrical machine, the electrical machine is also called a traction machine.

The storage device further comprises a clamping device, which comprises two endplates and at least one tension element connected to the endplates. The clamping device, i.e. the endplates and the tension element are the means, by which the storage cells arranged along the stacking direction between the endplates are clamped against each other along the stacking direction and therefore held together. To this end the tension element for example is tensioned/clamped along the stacking direction, so that a tension force is transmitted via the tension element from one of the endplates to the respectively other endplate or vice versa.

The tension force is a clamping force active along the stacking direction, by means of which the endplates functioning for example as pressure plates are pulled in the direction of/against the storage cells and are thus tensioned. This causes the storage cells to be pressed together and thus to be clamped against each other along the stacking direction. The tension element is thus subjected to tensile stress.

The storage device further comprises a temperature control device configured for controlling the temperature of, i.e. for cooling and/or heating, the storage cells, wherein at least the tension element is a functional component of the temperature control device. As a result the tension element comprises at least one duct through which a temperature control medium can flow to control the temperature of the storage cells. In addition the tension element comprises at least one supply port, via which the temperature control medium can be introduced into the duct. In addition the tension element comprises at least one drainage port, via which the temperature control medium can be drained/discharged out of the duct.

It is an object of the invention to provide a storage device of the kind mentioned in the beginning, so that the storage cells can be temperature-controlled in a particularly advantageous and installation-convenient manner.

The storage device according to the invention for storing electrical energy/electrical current for a motor vehicle, in particular for a motor car and preferably for a passenger car, comprises a plurality of storage cells successively arranged one after the other along a stacking direction and forming at least one cell stack for storing the electrical energy. The storage device is for example an energy supply device/an energy supply module, which can supply the electrical energy stored in the storage cells. This allows for example at least one electrical machine of the motor vehicle to be supplied with electrical energy stored in the storage device, in particular in the storage cells, so that the electrical machine can for example be operated in motor mode and thus for example as an electric motor. The motor vehicle can thus be electrically driven by means of the electrical machine, so that the motor vehicle is for example configured as a hybrid vehicle or electrical vehicle. In particular the storage device is configured as a high-voltage component, so that the storage device comprises/supplies an electrical voltage, in particular an electrical operating voltage, which is larger than 50 volt, in particular larger than 60 volt and preferably is several hundred volt. As a result large electrical outputs can be realized for driving the motor vehicle electrically. The storage device is for example a battery, in particular a high-voltage battery (HV battery) or a component part/module of such a battery.

The storage device further comprises at least one clamping device, which comprises two endplates and at least one tension element (which is also called a tie rod and is connected to the endplates). The storage cells arranged between the endplates along the stacking direction are clamped against each other along the stacking direction by means of the clamping device and thereby held together. To this end the tension element is tensioned/clamped along the stacking direction, so that a tension force is active in the/via the tension element. This tension force is transmitted via the tension element from one of the endplates to the respectively other endplate/or vice versa, so that the endplates also called pressure plates are pulled against the/in the direction of the storage cells and thus tensioned against the storage cells by means of the tension force also functioning as clamping force along the stacking direction. This causes the storage cells arranged between the endplates along the stacking direction to be pressed together along the stacking direction and thus to be held together. Since the clamping force for clamping the storage cells acts as a tension force in the tension element, the tension element is, in particular exclusively, under tensile stress.

The storage device further comprises a temperature control device configured for controlling the temperature of, i.e. for cooling and/or heating, the storage cells, wherein at least the tension element is a functional component part of the temperature control device. This means that the clamping device is integrated at least partially with the temperature control device or vice versa such that at least the tension element is integrated with the temperature control device or vice versa. As a result the tension element comprises at least one duct, through which a temperature control medium can flow to control the temperature of the storage cells. The temperature control medium is for example a fluid, in particular a gas such as for example air or a liquid, and can flow through the duct and thus the tension element.

The tension element comprises at least one supply port, via which the temperature control medium can be introduced into the duct and thus into the tension element. In addition the tension element comprises at least one drainage port, via which the temperature control medium can be drained/discharged out of the duct. For example in order to heat the storage cells by means of the temperature control medium, the temperature control medium, when flowing through the supply port, has for example a higher temperature than the storage cells. Subsequently a heat transition may occur from the temperature control medium via the tension element to the storage cells, as a result of which the storage cells are heated.

In order to, on the other hand, cool the storage cells by means of the temperature control medium for example, the temperature control medium, when flowing through the supply port, has for example a lower temperature than the storage cells. Subsequently a heat transition may occur from the storage cells via the tension element to the temperature control medium flowing through the duct, as a result of which the storage cells are cooled.

Now, in order to be able to realize a particularly advantageous, efficient and effective temperature control of the storage cells also with regard to constructional space, it is provided according to the invention that the tension element, when the storage device is installed, is arranged on a side of the storage cells, which in the vehicle vertical direction points upwards or preferably downwards. It has proven to be particularly advantageous if the tension element, when the storage device is installed, is arranged below the storage cells and thus on a downward-pointing side of the storage cells when viewed in the vehicle vertical direction. In the completely finished state of the motor vehicle the storage device assumes its installed position, wherein for example, when the motor vehicle in its completely finished state is positioned in a horizontal plane, the vehicle vertical direction coincides with the vertical direction and thus extends perpendicularly to the horizontal plane. It was found that due to the inventive arrangement of the tension element used as temperature control element for controlling the temperature of the storage cells, a particularly advantageous temperature control can be realized, wherein at the same time the constructional space needed for the storage device, in particular in the vehicle vertical direction also called z-direction, can be kept particularly low. For example, on the side on which the tension element is arranged, the storage cells have respective connection elements, which for example are also called terminals and which in particular may be respective electrical poles of the storage cells. For example, the storage cells, via the connection elements, may supply the electrical energy stored in the storage cells. Alternatively it is feasible that the connection elements of the storage cells are arranged on a further side of the storage cells which faces away from/lies opposite the side, on which the tension element is arranged.

Due to the integration of the tension element into the temperature control device, the tension element acquires a dual function. On one hand the tension element is utilized in order to clamp the storage cells along the stacking direction and thus hold them together. The tension element (also called a tie rod) ensures sufficient mechanical stability of the cell stack/the storage device as a whole. On the other hand, the tension element is utilized in order to control the temperature of the storage cells according to demand. Due to this dual function, functional integration has been achieved, so that the number of parts, the cost, the weight and the constructional space requirement of the storage device can all be kept at a particularly low level.

In order to be able to implement temperature control of the storage cells in a particularly economical and thus cost-effective manner, it is provided in an advantageous development according to the invention that the tension element comprises at least or preferably exactly two plates formed separately from each other and in particular releasably connected to each other in a non-destructible manner, each of which directly limits the duct. The feature that the plates each directly limit the duct is, in particular, to be understood as meaning that the temperature control medium flowing through the duct is in direct contact with the plates/with respective walls of the plates directly limiting the duct. Because of this the constructional space needed by the cooling device and thus by the storage device can be kept particularly low. In addition this results in a particularly efficient heat transition from the storage cells via at least one of the plates into the temperature control medium or vice versa.

It has become evident that it is particularly advantageous if the plates are firmly bonded to each other. In particular the plates are for example soldered to each other. It has proven to be particularly advantageous if the plates are welded to each other, in particular by means of laser welding. This allows the temperature control of the storage cells to be accomplished in a particularly economical manner.

In order to achieve particularly efficient cooling and/or heating, it is provided in a further development of the invention that the respective plate is made of a metallic material, in particular of at least one light metal. This ensures a particularly advantageous heat transition between the storage cells and the temperature control medium.

It has proven to be particularly advantageous if the metallic material comprises at least aluminum. It has proven to be particularly advantageous if the metallic material is an aluminum alloy, in particular a weldable aluminum alloy. On the one hand this ensures a particularly advantageous heat exchange between the temperature control medium and the storage cells. On the other this allows the overall weight of the storage device to be kept particularly low.

In order to keep the cost of the storage device particularly low, it is provided in a further development of the invention that a first one of the plates has a hollow cross-section which is basically open and directly limits a first part of the duct. The first plate is thus for example configured as a profile/profile part, wherein the first plate is configured in particular as a top-hat profile or a shell element and may thus comprise a trough-shaped/shell-shaped open hollow cross-section. The basically open hollow cross-section is closed by a planar/flat surface of the second plate directly limiting a second part of the duct. In other words, it is preferably provided that the second plate is configured to be at least essentially flat/planar, so that in particular the cost of the second plate and thus of the storage device as a whole can be kept particularly low. The first part is for example larger than the second part, wherein for example the first plate limits the duct on three sides, whilst the planar surface limits the duct on a fourth side. This allows temperature control to be realized in a particularly low-cost manner.

In order to keep stresses and also the weight of the storage device particularly low, a wall thickness ratio of the plates in a range of including 1:1 to including 3:1 was found to be advantageous. Preferably the wall thickness ratio is 3:1. In other words it is preferably provided that the respective plate comprises a respective wall thickness, which is also called wall strength. A ratio of the wall thickness of the first plate to the wall thickness of the second plate preferably lies in a range from including 1:1 to including 3:1, wherein the ratio is preferably 3:1. The open hollow cross-section of the first plate is for example formed by embossing the first plate, so that the first plate is for example formed as an embossed plate.

It has proven to be particularly advantageous if the second plate is arranged between the first plate and the storage cells, so that for example a heat exchange between the temperature control medium flowing through the duct and the storage cells takes place via the second plate. If in this case the ratio of the wall thickness of the first plate to the wall thickness of the second plate is greater than 1 and if the ratio is preferably 3:1, a particularly efficient heat exchange can for example take place between the temperature control medium flowing through the duct and the storage cells via the second plate. In this case the first plate can ensure sufficient mechanical stability and thus for example avoid undesired leakages.

A further embodiment is characterized in that of the plates only one of the plates or both plates are connected, in particular firmly bonded, to the respective endplate. For example the one plate/both plates are connected to the respective endplate by welding and preferably by laser welding and/or by gluing.

In order to for example achieve a particularly homogenous introduction of tension into the tension element, it is preferably provided that at least 80 percent of a width of the tension element/the respective plate extending perpendicularly to the stacking direction is connected, in particular firmly bonded, to the respective endplate and is thus glued and/or welded to the respective endplate.

In order to be able to achieve a particularly economical temperature control of the storage cells, it is provided in a further development of the invention that the tension element is firmly bonded to the respective endplate, in particular by welding and preferably by laser welding and/or by gluing.

Finally it has proven to be particularly advantageous if at least one insulation element is arranged along the stacking direction between the respective endplate and the cell stack, by means of which the cell stack is thermally insulated against the respective endplate. In other words, the respective endplate is directly followed by a respective one of the storage cells along the stacking direction. This is to be understood in particular as meaning that there is no further other storage cell arranged between the respective endplate and the respective storage cell directly following the respective endplate along the stacking direction. The respective storage cell directly/immediately following the respective endplate along the stacking direction is also called adjacent storage cell because it is arranged next to the respective endplate. Thus at least one insulation element is arranged between the respective endplate and the respective storage cell adjacent to the respective endplate, by means of which the respective adjacent cell is thermally insulated against the respective endplate. This makes it possible to achieve particularly homogenous temperature control, in particular cooling of the storage cell. The insulation element is for example formed separately from the storage cells and separately from the endplates. Alternatively or additionally the insulation element is formed from a plastic.

In order to achieve particularly good thermal insulation, the insulation element has air enclosed in its interior, which forms 50% to 90%, in particular 70% to 80% of the total volume of the insulation element. In other words, the insulation element contains for example at least one or more, in particular large, air inclusions. To this end the insulation element in its interior comprises for example at least one or more chambers, in which air is received. This allows the respective endplate to be thermally particularly well insulated against the cell stack. The insulation element is preferably formed as a plate. Since, however, the storage cells are pressed together by means of the endplates, it is desirable that the respective endplate has sufficient pressure stability. Air inclusions at a rate of 50 to 90 percent have proven to be an advantageous compromise between insulation and pressure stability. Rates of 70 to 80 percent are particularly optimal. In other words, 50 to 90 percent, in particular 70 to 80 percent of the volume of the insulation element consists of air/air inclusions or of exactly one air inclusion in the insulation element, in particular in the interior thereof.

Further details of the invention are revealed in the description hereunder of a preferred exemplary embodiment with associated drawings.

### BRIEF DESCRIPTION OF THE DRAWINGS

FIG. 1 is a schematic and perspective explosive view of a storage device according to an embodiment of the invention for storing electrical energy for a motor vehicle.

FIG. 2 is a schematic and perspective explosive view of a clamping device of the storage device.

FIG. 3 is a schematic front view of the storage device.

In the figs. identical or functionally identical elements have been marked with the same reference symbols.

### DETAILED DESCRIPTION OF THE DRAWINGS

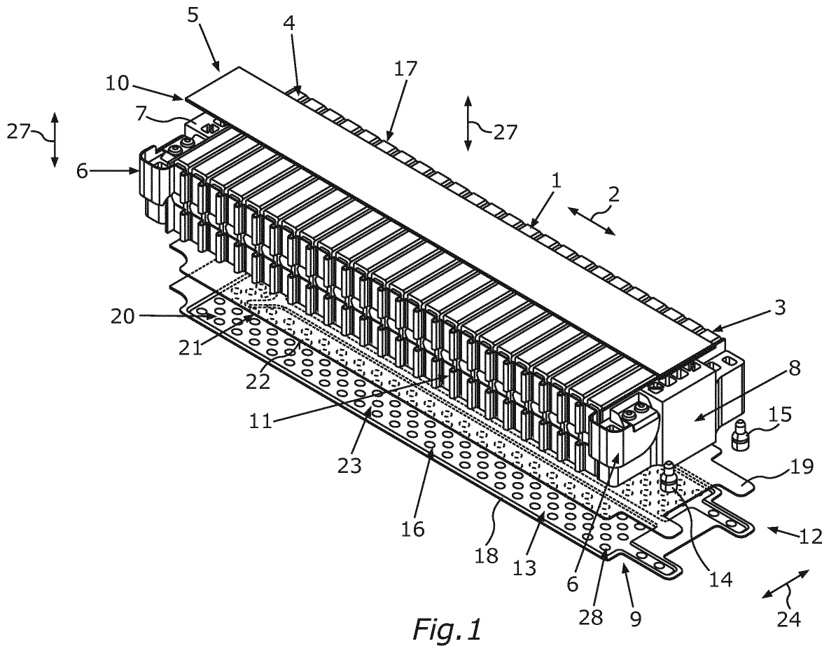

FIG. 1, in a schematic and perspective explosive view, shows a storage device 1 for storing electrical energy for a motor vehicle, which for example is configured as a motor car and preferably as a passenger car. The motor vehicle is configured as a hybrid vehicle or electrical vehicle and comprises at least one electrical machine by means of which the motor vehicle can be electrically driven. This is why the electrical machine is also called a traction machine. The storage device 1 comprises a plurality of storage cells 4 successively arranged (arranged one after the other) along a stacking direction depicted in FIG. 1 by a dual arrow 2 and forming at least one cell stack 3, the storage cells being a means for storing the electrical energy. The storage cells 4 are respectively individual cells/are also denoted as individual cells because the storage cells 4 are formed separately from each other and are basically individual/loose components. As still to be discussed in more detail below, the storage device 1 also comprises a clamping device 5 also denoted as a frame or cell frame, by means of which the storage cells 4 are clamped against each other along the stacking direction and thereby held together.

The storage device 1 can supply the electrical energy stored in the storage cells 4, so that for example the electrical machine can be supplied with electrical energy stored in the storage device 1. This allows the electrical machine to be operated in a motor mode and thus as an electric motor, by means of which the motor vehicle can be electrically driven. Furthermore it is feasible that the electrical machine can be operated in a generator mode and thus as a generator. In generator mode the electrical machine is for example driven by at least one wheel of the moving motor vehicle and thus by kinetic energy of the motor vehicle. At least part of the kinetic energy of the motor vehicle is converted by the generator into electrical energy which is supplied by the generator. The electrical energy produced by the generator may for example be fed to the storage device 1 and in particular to the storage cells 4 and stored in the storage cells 4.

The storage device 1 is preferably a high-voltage component, which comprises/supplies an electrical voltage, in particular an electrical operating voltage, wherein the electrical voltage, in particular the electrical operating voltage is higher than 50 volt, in particular higher than 60 volt and preferably is several hundred volt. This allows high electrical outputs for electrically driving the motor vehicle to be realized.

The storage device 1 comprises power taps 6, via which for example the storage device 1 can supply the electrical voltage. In particular the electrical energy stored in the storage cells 4 can be withdrawn via the power taps 6 from the storage device 1, so that the storage device 1 can provide the electrical energy stored in the storage cells 4 via the power taps 6. In particular it is feasible that the electrical energy provided by the generator can be stored in the storage cells 4 via the power taps 6. The storage device 1 is configured in particular as a high-voltage battery (HV battery), so that for example the respective storage cell 4 is configured as a respective battery cell. In particular the storage device 1 may be configured as a lithium-ion battery, so that the respective storage cell 4 may for example be configured as a lithium-ion cell.

The clamping device 5 also comprises two endplates 7 and 8 also called pressure plates, wherein the storage cells 4/the cell stack 3 are/is arranged between the endplates 7 and 8 along the stacking direction (dual arrow 2). In addition the clamping device 5 comprises a first tension element in the form of a first tie rod 9 and a second tension element in the form of a second tie rod 10. The tie rods 9 and 10 are connected to the respective endplates 7 and 8 and tensioned along the stacking direction, so that at least a tension force is active in each of the tie rods 9 and 10 along the stacking direction. The respective tension force is transmitted via the respective tie rod 9/10 from one of the endplates 7 and 8 to the respectively other endplate 8/7 or vice versa, so that the endplates 7 and 8 are clamped against the cell stack 3 by means of the respective tension force functioning as a clamping force. The tension force active in the tie rods 9 and 10 acts as a pressure force via the endplates 7 and 8 onto the storage cells 4, which are pressed together by means of the pressure force along the stacking direction and thereby are held together and clamped against one another. This is why the endplates 7 and 8 are also called pressure plates. In addition the storage device 1 comprises so-called cell connectors 11, via which for example the storage cells 4 are electrically and/or mechanically connected among each other.

In order to be able to ensure that the storage device 1 operates efficiently and effectively, even at different ambient temperatures, the storage device 1 additionally comprises a temperature control device 12, by means of which the storage cells 4 can be temperature-controlled, i.e. cooled and/or heated. This means that at least the tie rod 9 is a functional component part of the temperature control device 12. In other words at least the tie rod 9 is integrated with the temperature control device 12, in particular such that the tie rod 9 comprises at least one duct 13 through which a temperature control medium can flow for controlling the temperature of the storage cells 4. The temperature control medium is preferably a fluid, in particular a gas such as for example air or a liquid, wherein the temperature of the storage cells 4 can be controlled in terms of a heat exchange between the storage cells 4 and the temperature control medium by means of the temperature control medium.

Due to the tie rod 9 being integrated with the temperature control device 12, the tie rod 9 has at least one supply port 14 configured for example as a VDA connecting piece, via which the temperature control medium can be introduced into the duct 13 also called temperature control duct. In addition the tie rod 9, due to being integrated with the temperature control device 12, has at least one drainage port 15 configured for example as a VDA connecting piece, via which the temperature control medium, once it has flown through the duct 13, can be drained/discharged from the duct 13.

Now in order to be able to control the temperature of the storage cells 4 particularly efficiently and effectively as well as in a low-cost and space-saving manner, the tie rod 9 integrated with the temperature control device 12 is arranged, with the storage device 1 installed, on a side 16 of the storage cells 4/the cell stack 3, which in the vehicle vertical direction is pointing downward. In the completely finished state of the motor vehicle the storage device 1 assumes its installed position, wherein the installed position of the storage device 1 is shown in FIG. 1. A dual arrow 27 in FIG. 1 indicates the vehicle vertical direction. If for example the motor vehicle, in its completely finished state, stands on a horizontal plane, the vehicle vertical direction extends in the vertical direction at least essentially perpendicularly to the plane. Since in this case the side 16, in the vehicle vertical direction/vertical direction, points downwards and thus in the direction of the plane, the tie rod 9 is arranged below the storage cells 4, so that the tie rod 9 is a lower tie rod.

The tie rod 10, with regard to the temperature control device 12, is an external component and thus different from the temperature control device 12. This means that the tie rod 10 is not integrated with the temperature control device 12/is not a functional component part of the temperature control device 12. In particular the tie rod 10 does not comprise a duct through which the temperature control medium can flow. In FIG. 1 it can be recognized particularly well that the tie rod 10, with the storage device 1 in the installed position, is, in the vehicle vertical direction, arranged on an upward-pointing side and thus on a further side 17 opposite side 16 of the storage cells 4/the cell stack 3. Thus for example the side 17 faces away from the previously described plane, when the motor vehicle in its completely finished state stands on the horizontal plane. The sides 16 and 17, in the vehicle vertical direction, are thus sides lying opposite each other/facing away from each other, which have the tie rods 9 and 10 arranged on them. Since the tie rod 10 is arranged on the upward-pointing side 17 (with regard to the installed position) of the storage cells 4 in the vehicle vertical direction, the tie rod 10 is an upper tie rod of the clamping device 5.

As explained in still more detail hereunder, the tie rod 9 is configured as a temperature control plate, which in particular can function as a cooling plate during cooling of the storage cells 4. With the storage device 1, the temperature control plate is configured such that it can take over both the structural tasks of the tie rod 9 and the tasks for controlling the temperature of the storage cells 4. If a cooling plate or a temperature control plate is mentioned hereunder, this is understood to mean the tie rod 9 functioning as a temperature control element, since the tie rod 9 is/can be used for temperature control and thus in particular for cooling and/or heating the storage cells 4. A particularly advantageous function and important task of the tie rod 9 is in particular the cooling of the storage cells 4, in order to avoid excessively high temperatures of the storage cells 4. The tie rod 9 in particular thus functions as a cooler/cooling plate for cooling the storage cells 4.

In the embodiment shown in the figs. the temperature control plate (tie rod 9) comprises exactly two separately configured plates 18 and 19 which are connected with each other and configured as cooling plates in particular when the tie rod 9 is used for cooling the storage cells 4. Plate 18 is a first lower plate, whilst plate 19 is a second upper plate, since plate 19, with respect to the installation position of the storage device 1, is arranged in the vehicle vertical direction between the storage cells 4 and plate 18, and thus on top of/above plate 18.

Plate 18 is for example configured as a profile/profile part. To this end plate 18 is for example embossed, so that plate 18 is for example configured as an embossed plate. As a result plate 18 comprises a basically open hollow cross-section 28 forming/directly limiting a first part 20 of the duct 13, which is closed by a planar surface 22 of the second plate 19 forming/directly limiting a second part 21 of the duct 13. The second plate 19 is at least predominantly, in particular completely, configured as a plane/flat plate, so that the surface 22 at least predominantly, in particular completely, is planar/flat. As a result the cost of the plate 19 and thus of the storage device 1 can be kept particularly low.

As can be particularly well recognized in FIG. 1, the plate 18 comprises for example a plurality of projections 23 protruding into the duct 13, which are for example formed through embossing the plate 18. In particular a number of ducts of the tie rod 9 can for example be formed in the above-described manner, which can function as cooling ducts and through which the temperature control medium can flow. In order to realize a particularly advantageous temperature control of the storage cells 4, the plates 18 and 19 are preferably formed from a weldable aluminum alloy. Preferably the plates 18 and 19 functioning for example as cooling plates are firmly bonded to each other and in particular soldered and/or welded to each other, wherein welding of the plates 18 and 19 has proven to be particularly advantageous.

In order to achieve an advantageous mechanical connection, the tie rod 9 is for example firmly bonded to the respective endplates 7 and 8, in particular welded and/or glued. In other words, the tie rod 9 is for example welded and/or glued to the endplates 7 and 8 functioning as pressure plates. This may be realized in such a way that of the plates 18 and 19 merely one plate 18 or 19 or even both plates 18 and 19 of the tie rod 9 is/are welded to the endplates 7 and 8. The tie rod 9 is for example bonded to the endplates 7 and 8 in such a way that welding is performed right through both plates 18 and 19. Laser welding has proven to be particularly advantageous in order to weld the tie rod 9 to the respective endplates 7 and 8. Other welding methods are however by all means feasible. Furthermore it is possible that the tie rod 9 is glued to the respective endplate 7 or 8 and/or is screwed to the respective endplate 7 or 8. In order to ensure that tension is introduced into the temperature control plate (tie rod 9) in a homogenous manner, preferably at least 80 percent of a width of the tie rod 9 is glued and/or welded to the respective endplate 7 or 8, wherein the said width extends along a direction perpendicular to the stacking direction and indicated in FIG. 1 by a dual arrow 24. The direction indicated by the dual arrow 24 is for example also denoted as the transverse direction of the storage device 1.

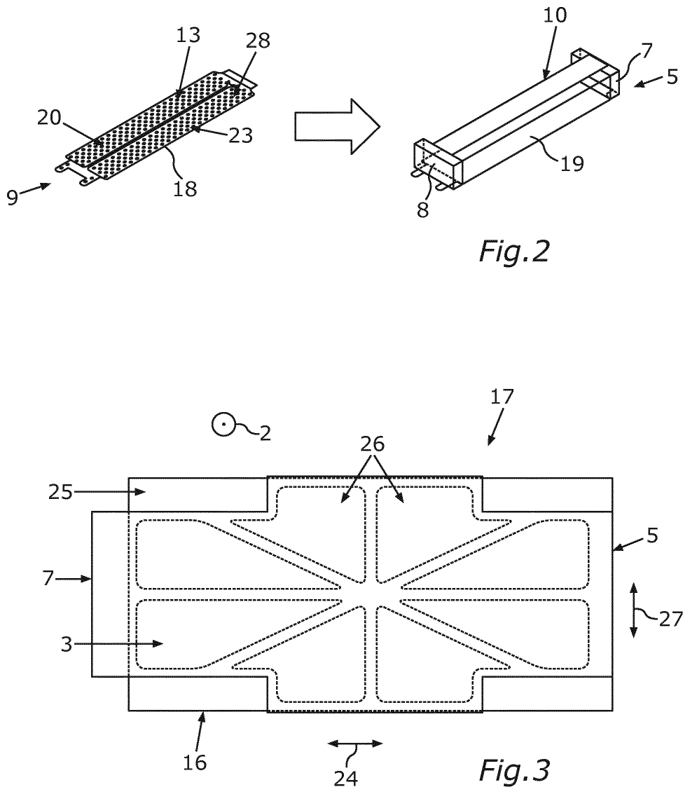

FIG. 2 shows the clamping device 5 in a schematic explosive view. FIG. 2 shows particularly well that the clamping device 5 forms for example a frame, by means of which the individual cells are held together and thus are connected to each other. Since the plate 19 is arranged between the storage cells 4 and the plate 18/the duct 13 and is for example formed from a metallic material and in particular from a metal sheet, the plate 19 is for example a heat conducting plate, via which a particularly advantageous heat exchange can take place between the temperature control medium flowing through the duct 13 and the storage cells 4. It was found that in order to realize a particularly advantageous temperature control, in particular cooling, of the storage cells 4, the following two points are particularly relevant:
Temperature control/in particular cooling of the storage cells 4 is to be effected in an at least essentially uniform manner;
In order to efficiently use an existing cooling capacity, the introduction of ambient heat into the temperature control plate should be avoided.

The above points can be realized as follows: the storage device 1 configured as a module, in particular a cell module, is for example connected at respective connecting points to a support structure of the motor vehicle. Thermal insulation is preferably provided at the connecting points. In particular in the case of a screw connection at the connecting points it has proven to be advantageous, after balancing function, weight and cost against each other, to use a thermal insulation with a thickness of 0.5 to 2 millimeters and a thermal conductivity of max. 0.2 W/m K (watt per meter Kelvin). In other words, the storage device 1 comprises for example connecting points not discernible in the figs., at which/via which the storage device 1 can be connected to a support structure of the motor vehicle not depicted in the figs. Preferably a thermal insulation is provided at the connecting points, which is for example formed by at least one thermal insulation element. The thermal insulation preferably comprises a thickness in a range from including 0.5 millimeters to including 2 millimeters. Alternatively or additionally the thermal insulation preferably comprises a thermal conductivity of max. 0.2 W/m K.

In order to achieve an at least essentially homogenous temperature control, in particular cooling, it has proven to be advantageous to thermally insulate the respective endplates 7 and 8 against the cell stack 3. To this end—as particularly clearly depicted in FIG. 3—at least one insulation element 25 is for example arranged between the respective endplate 7/8, by means of which the cell stack 3 is thermally insulated against the respective endplate 7/8. This can be recognized by way of the exemplary endplate 7 in FIG. 3, wherein the previous and successive statements regarding the endplate 7 can be applied without problems to the endplate 8 and vice versa. The insulation element 25 is configured as a plate/insulation plate, which for example is formed from a plastic. The endplate 7 in FIG. 3 is shown as being transparent, so that the cell stack 3 arranged behind the endplate 7 with respect to the image plane of FIG. 3 and the insulation element 25 arranged at least partially behind the endplate 8 with respect to the image plane in FIG. 3 can be recognized. In FIG. 3 it can be particularly well recognized that the insulation element 25 comprises for example a plurality of chambers 26. The chambers 26 may for example be completely closed in particular by walls of the insulation element 25. With the embodiment shown in FIG. 3 it is for example provided that the chambers 26 are basically open along the stacking direction and are closed along the stacking direction on the one hand by the cell stack 3, i.e. by at least one of the storage cells 4, and on the other hand by the respective endplate 7/8. The chambers 26 are air chambers, in which air is received/enclosed. As a result, particularly good thermal insulation can be ensured. The percentage of the chambers 26 configured as air chambers of the total volume of the insulation element 25 lies for example in a range from including 50 percent to including 90 percent, preferably in a range from including 70 percent to including 80 percent. This ensures that a particularly efficient and effective thermal insulation can be achieved.

### LIST OF REFERENCE SYMBOLS

1 storage device
2 dual arrow
3 cell stack
4 storage cell
5 clamping device
6 power tap
7 endplate
8 endplate
9 tie rod
10 tie rod
11 cell connector
12 temperature control device
13 duct
14 supply port
15 drainage port
16 side
17 side
18 plate
19 plate
20 first part
21 second part
22 surface
23 projections
24 dual arrow
25 insulation element
26 chamber
27 dual arrow
28 open hollow cross-section

1.-11. (canceled)

12. A storage device for storing electrical energy for a motor vehicle, comprising:
a plurality of storage cells arranged one after another along a stacking direction and forming at least one cell stack for storing the electrical energy;
a clamping device comprising two endplates and at least one tension element connected to the endplates, by which clamping device the storage cells arranged between the endplates along the stacking direction are clamped against each other along the stacking direction and thereby are held together; and
a temperature control device for controlling a temperature of the storage cells, wherein
at least the tension element is a functional component part of the temperature control device and comprises: at least one duct through which a temperature control medium is flowable for controlling the temperature of the storage cells, at least one supply port via which the temperature control medium is introduced into the duct, and at least one drainage port via which the temperature control medium is drained from the duct, and
the tension element, in an installed position of the storage device, is arranged on an upward or downward pointing side of the storage cells in a vehicle vertical direction.

13. The storage device according to claim 12, wherein
the tension element comprises at least or exactly two plates configured separately from and connected to each other, each of which directly limits the duct.

14. The storage device according to claim 13, wherein
the two plates are firmly bonded.

15. The storage device according to claim 14, wherein
the two plates are welded or soldered to each other.

16. The storage device according to claim 13, wherein
a respective plate is formed from a metallic material.

17. The storage device according to claim 16, wherein
the metallic material comprises at least aluminum.

18. The storage device according to claim 14, wherein
a first one of the two plates comprises a hollow cross-section directly limiting an open, first part of the duct, which is closed by a planar surface of the second plate directly limiting a second part of the duct.

19. The storage device according to claim 14, wherein
a wall thickness ratio of the two plates lies in a range from including 1:1 to including 3:1.

20. The storage device according to claim 14, wherein
only one of the two plates is firmly bonded to a respective endplate.

21. The storage device according to claim 14, wherein
both of the two plates are firmly bonded to the respective endplates.

22. The storage device according to claim 12, wherein
the tension element is firmly bonded to a respective endplate by welding and/or by gluing.

23. The storage device according to claim 12, further comprising:
at least one insulation element arranged along the stacking direction between a respective endplate and the cell stack, by which the cell stack is thermally insulated from the respective endplate.

24. The storage device according to claim 23, wherein
the insulation element comprises air enclosed in its interior, which forms 50% to 90% of the total volume of the insulation element.

25. The storage device according to claim 24, wherein
the air forms 70% to 80% of the total volume of the insulation element.
